(19) United States
(12) Patent Application Publication
(10) Pub. No.: US 2021/0339420 A1
(43) Pub. Date: Nov. 4, 2021

(54) CHAINSAW

(71) Applicant: MILWAUKEE ELECTRIC TOOL CORPORATION, Brookfield, WI (US)

(72) Inventor: Jeremy R. Ebner, Milwaukee, WI (US)

(21) Appl. No.: 17/377,102

(22) Filed: Jul. 15, 2021

Related U.S. Application Data
(63) Continuation of application No. 15/440,830, filed on Feb. 23, 2017.
(60) Provisional application No. 62/298,687, filed on Feb. 23, 2016.

(51) Int. Cl. B27B 17/00; B27B 17/12; B27B 17/02; B27B 17/08

(52) U.S. Cl. CPC B27B 17/0008; B27B 17/086; B27B 17/02; B27B 17/12

(57) ABSTRACT

A chainsaw includes a housing including a handle housing portion, a motor housing portion, and a drive housing portion. The handle housing portion has a cavity extending along a longitudinal axis defining a first axis. A motor includes an output shaft having a longitudinal axis that defines a second axis. The chainsaw also includes a driven gear coupled to the output shaft, a sprocket coupled to the driven gear such that rotation of the driven gear rotates the sprocket, and a guide bar extending from the drive housing portion and having a longitudinal axis that defines a third axis of the chainsaw. The first and second axes define an included angle less than 75 degrees, the second and third axes define a second included angle between 110 degrees and 130 degrees, and the first and third axes define an external angle between 150 degrees and 170 degrees.

### CROSS-REFERENCE TO RELATED APPLICATIONS

This application is a continuation of co-pending U.S. patent application Ser. No. 15/440,830, filed Feb. 23, 2017, which claims priority to co-pending U.S. Provisional Patent Application No. 62/298,687 filed on Feb. 23, 2016, the entire content of each of which is incorporated herein by reference.

### BACKGROUND

The present disclosure relates to chainsaws, and more particularly to portable, battery-powered chainsaws.

Chainsaws are typically large and heavy, requiring two-handed operation. Prolonged use of such chainsaws may lead to operator fatigue. In addition, the weight and size of such chainsaws may render them impractical for use in overhead, confined, or other difficult cutting positions.

### SUMMARY

The disclosure provides, in one aspect, a chainsaw including a housing having a handle housing portion, a motor housing portion, and a drive housing portion. The handle housing portion has a longitudinal axis that defines a first axis of the chainsaw. The chainsaw also includes a motor supported by the motor housing portion and having an output shaft with a longitudinal axis that defines a second axis of the chainsaw. The chainsaw further includes a driven gear coupled to the output shaft such that the driven gear rotates in response to rotation of the output shaft, a sprocket coupled to the driven gear such that rotation of the driven gear rotates the sprocket, and a guide bar extending from the drive housing portion and having a longitudinal axis that defines a third axis of the chainsaw. A chain is supported on the guide bar and engaged with the sprocket such that rotation of the sprocket moves the chain along the guide bar. The first axis, the second axis, and the third axis are generally coplanar, and the first axis and the second axis define a first included angle between about 75 degrees and about 95 degrees.

The disclosure provides, in another aspect, a chainsaw including a housing having a handle housing portion, a motor housing portion, and a drive housing portion. The handle housing portion has a longitudinal axis that defines a first axis of the chainsaw. The chainsaw also includes a motor supported by the motor housing portion. The motor includes an output shaft having a longitudinal axis that defines a second axis of the chainsaw. A guide bar extends from the drive housing portion and has a longitudinal axis that defines a third axis of the chainsaw. The chainsaw further includes a chain supported on the guide bar. The first axis and the second axis define a first included angle between about 75 degrees and about 95 degrees, the second axis and the third axis define a second included angle between about 110 degrees and about 130 degrees, and the first axis and the third axis define an external angle between about 150 degrees and about 170 degrees.

The disclosure provides, in another aspect, a chainsaw including a housing having a handle housing portion with a cavity and a longitudinal axis that defines a first axis of the chainsaw. The chainsaw also includes a motor supported within the housing and having an output shaft with a longitudinal axis that defines a second axis of the chainsaw. The chainsaw further includes a battery configured to provide power to the motor, the battery being received in the cavity along the first axis. A guide bar extends from the housing and has a longitudinal axis that defines a third axis of the chainsaw. The chainsaw further includes a chain supported on the guide bar, and the chain includes a plurality of cutting elements. The first axis, the second axis, and the third axis are generally coplanar, and the first axis, the second axis, and the third axis are oblique with respect to each of the other axes.

Other features and aspects of the disclosure will become apparent by consideration of the following detailed description and accompanying drawings.

### BRIEF DESCRIPTION OF THE DRAWINGS

FIG. 1 is a side view of a portable hand tool according to one embodiment.

FIG. 2 is another side view of the portable hand tool of FIG. 1.

FIG. 3 is a cross-sectional view of the portable hand tool of FIG. 1.

Before any embodiments of the disclosure are explained in detail, it is to be understood that the disclosure is not limited in its application to the details of embodiment and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

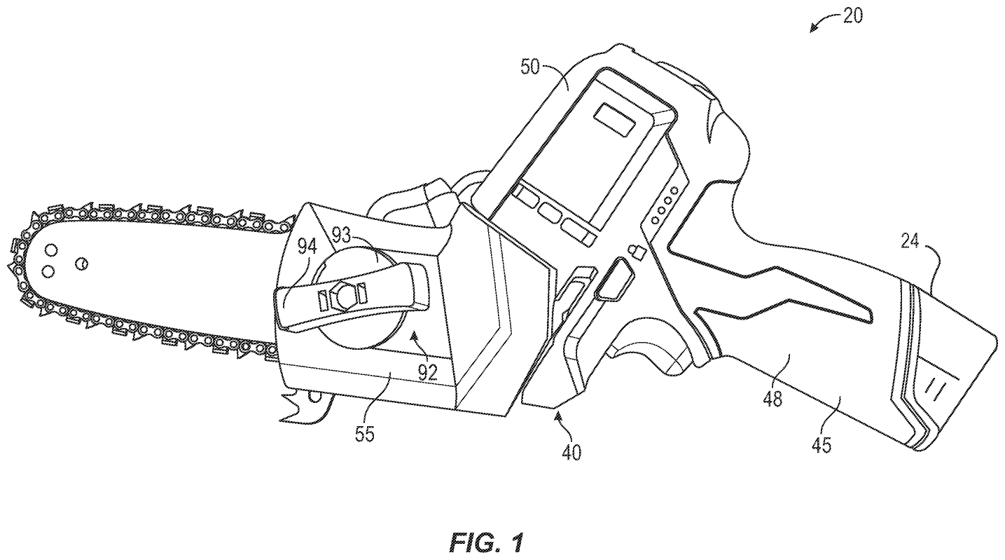

FIGS. 1-3 illustrate a portable hand tool 20 or a portable chainsaw according to one embodiment. The chainsaw 20 is powered by a rechargeable power tool battery pack 24 (FIG. 1). For example, the illustrated battery pack 24 is an interchangeable battery pack configured to connect to and power a variety of tools in addition to the chainsaw 20. In some embodiments, the battery pack 24 is a 12-volt lithium-ion battery pack including three battery cells (not shown) connected in series. In other embodiments, the battery pack 24 may include fewer or more battery cells, and the battery pack 24 may have other nominal output voltages, such as 14.4 volts, 18 volts, etc. Additionally or alternatively, the battery cells may have chemistries other than lithium-ion such as, for example, nickel cadmium, nickel metal-hydride, or the like. In still other embodiments, the chainsaw 20 may be a corded power tool.

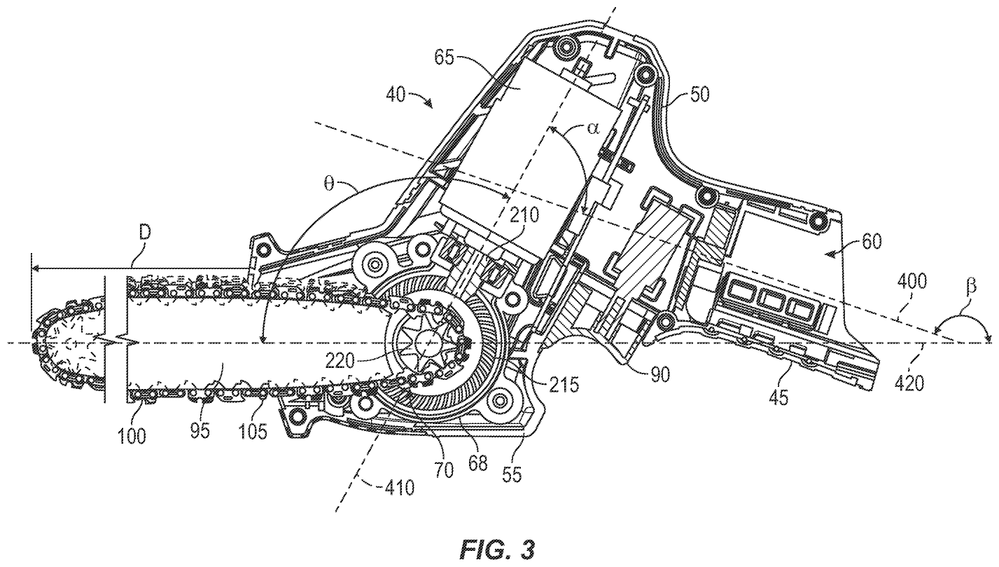

With continued reference to FIG. 1, the chainsaw 20 includes a housing 40. The housing 40 defines a handle housing portion 45, a motor housing portion 50 and a drive housing portion 55. The handle housing portion 45 includes at least one grip surface 48 for a user to grasp while operating the chainsaw 20. In the illustrated embodiment, the handle housing portion 45 includes a battery receiving portion 60 (FIG. 3) for receiving at least a portion of the battery pack 24. In other embodiments, the battery receiving portion 60 may be defined elsewhere on or within the housing 40. An electric motor 65, which may be, for example, a brushed or brushless DC motor, is supported within the motor housing portion 50. A drive mechanism 70, located in the drive housing portion 55, is mechanically coupled to the electric motor 65.

Referring to FIGS. 1 and 3, the illustrated battery receiving portion 60 is configured as a cavity. When the battery pack 24 is connected to the chainsaw 20, the pack 24 is inserted into the cavity 60 and substantially fills the cavity 60. In other embodiments, the battery pack 24 may couple with the battery receiving portion 60 in other ways, such as with an external rail structure. A terminal block is positioned in the cavity 60 to electrically connect the battery pack 24 to the motor 65. A switch 90 is positioned on the handle housing portion 45 for operating the chainsaw 20. As illustrated, the switch 90 is an on/off trigger switch. In other embodiments, the switch 90 may be a variable speed trigger switch, a two speed trigger switch, a push button, or any other suitable actuator. A knob 92 is positioned on a lateral side (i.e. a left side in the illustrated embodiment) of the drive housing portion 55 (FIG. 1). The knob 92 includes a rounded portion 93 adjacent the drive housing portion 55 and a graspable wing portion 94 extending from the rounded portion 93.

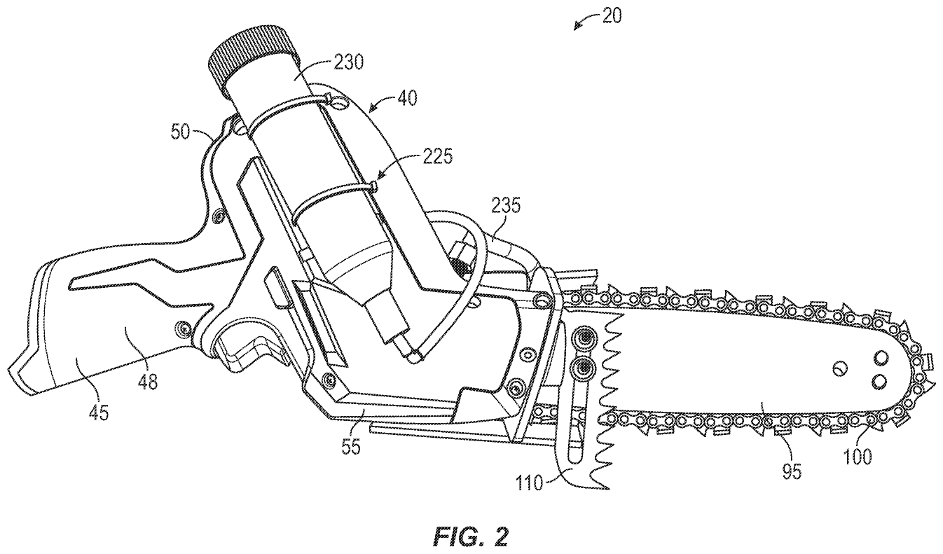

With continued reference to FIG. 3, the chainsaw 20 further includes a guide bar 95 extending from the drive housing portion 55. The guide bar 95 supports a saw chain 100 having a plurality of cutting elements 105. The cutting elements 105 may have any desired configuration, such as full chisel, semi-chisel, chipper, or the like. Referring to FIG. 2, an adjustable bumper spike 110 is coupled to the drive housing portion 55. The bumper spike 110 may be used to engage a workpiece and provide a pivot point during a cutting operation. In other embodiments, the bumper spike 110 may be omitted.

The drive mechanism 70 includes a driving gear 210 and a driven gear 215 (FIG. 3). In the illustrated embodiment, the driving gear 210 is a spiral bevel pinion and the driven gear 215 is a spiral bevel gear. The driven gear 215 is oriented with its teeth facing the left side of the drive housing portion 55. In other embodiments, the driving gear 210 and driven gear 215 may have other configurations. In addition, one or more reduction gears may be provided between the driving gear 210 and the driven gear 215. A sprocket 220 is coupled to the driven gear 215 for rotation therewith. The saw chain 100 wraps around the sprocket 220 such that rotation of the sprocket 220 advances the saw chain 100 along the guide bar 95. In some embodiments, the sprocket 220 may be integrally formed with the driven gear 215. In other embodiments, the sprocket 220 may be provided as part of the guide bar 95.

With reference to FIG. 2, the chainsaw 20 further includes a lubrication system 225 for supplying lubrication (e.g., bar and chain oil) to the drive mechanism 70, the saw chain 100, and/or the guide bar 95. The lubrication system 225 includes a lubricant reservoir 230 and a conduit 235 extending from the reservoir 230 into the drive housing portion 55 of the housing 40. In the illustrated embodiment, the lubricant reservoir 230 is located on the exterior of the housing 40. In other embodiments, the lubricant reservoir 230 may be located fully or partially within the housing 40. In other embodiments, the chainsaw 20 may not include a lubrication system.

Referring to FIG. 3, in some embodiments, the guide bar 95 defines an overall length between about 6 inches and about 16 inches. In other embodiments, the guide bar 95 defines an overall length between about 8 inches and about 14 inches. In the illustrated embodiment, the overall length of the bar 95 is about 11 inches. The guide bar 95 projects from the forward-most edge of the drive housing portion 55 by a distance D. In some embodiments, the distance D is between about 3 inches and about 12 inches. In other embodiments, the distance D is between about 4 inches and about 10 inches. In other embodiments, the distance D is between about 4 inches and about 8 inches. In the illustrated embodiment, the distance D is about 6 inches. Accordingly, in the illustrated embodiment, a ratio of the distance D to the overall length of the guide bar 95 is about 0.5.

With continued reference to FIG. 3, the battery pack 24 is insertable into the battery cavity 60 of the chainsaw 20 along a handle axis 400, which also defines a battery insertion axis. The motor 65 defines a longitudinal motor axis 410 along a length of the motor 65. The guide bar 95 is positioned along a longitudinal or cutting axis 420 defined along the length of the guide bar 95. In the illustrated embodiment, the axes 400, 410, 420 are positioned such that each axis 400, 410, 420 is coplanar. In addition, the axes 400, 410, 420 are oblique, or not otherwise perpendicular and/or parallel with respect to the other axes. More specifically, the handle axis 400 is positioned at an angle α with respect to the motor axis 410, the motor axis 410 is positioned at an angle θ with respect to the longitudinal axis 420, and the longitudinal axis 420 is positioned at an angle β with respect to the handle axis 400. In some embodiments, each of the axes 400, 410, 420 may be either non-parallel or non-orthogonal with respect to each of the other axes 400, 410, 420.

In the illustrated embodiment, each of the axes 400, 410, 420 is oblique with respect to the other axes 400, 410, 420. Angle α is an angle defined between the handle axis 400 and the motor axis 410 and is in a range of about 75 degrees to about 95 degrees. In the illustrated embodiment, angle α is about 85 degrees. In still other embodiments, angle α may be greater than 95 degrees or less than 75 degrees. Angle θ is an angle defined between the motor axis 410 and the longitudinal axis 420 and is an obtuse angle in some embodiments. For example, the the angle θ may be in a range between about 110 degrees and about 130 degrees. In the illustrated embodiment, angle θ is about 120 degrees. In other embodiments, angle θ may be greater than 130 degrees or less than 110 degrees. Angle β is an angle defined between the handle axis 400 and the longitudinal axis 420 and is in a range of about 150 degrees to about 170 degrees. In the illustrated embodiment, angle β is about 161.7 degrees. In other embodiments, angle β is greater than 170 degrees or less than 150 degrees.

The position of the axes, the size of the chainsaw 20, the length of the guide bar 95, and other characteristics are designed for optimal cutting, portability, and ergonomics. For example, the orientation of motor 65 and the position of the motor 65 generally above the guide bar 95 (with reference to the orientation of FIG. 2) allows the chainsaw 20 to be more compact by reducing the overall length of chainsaw 20 as compared to the length of a conventional chainsaw. The handle axis 400 is oriented for optimal user operation with regard to handle grip location and angle for performing a cutting operation. Finally, the chainsaw 20 is relatively lightweight, weighing between about 3 pounds and about 7 pounds (excluding the battery pack) in some embodiments. In the illustrated embodiment, the chainsaw 20 weighs between about 4 pounds and about 5 pounds. The foregoing features and characteristics facilitate one-handed operation of the chainsaw 20, as well as use of the chainsaw 20 in a variety of different operating positions.

Various features of the disclosure are set forth in the following claims.

What is claimed is:

1. A chainsaw comprising:
a housing including a handle housing portion, a motor housing portion, and a drive housing portion, the handle housing portion having a cavity extending along a longitudinal axis that defines a first axis of the chainsaw and at least one grip surface configured to be grasped during operation of the chainsaw;
a knob positioned on a lateral side of the drive housing portion, the knob including a round portion adjacent the drive housing portion and a graspable portion coupled to the round portion;
a motor supported within the motor housing portion, the motor including an output shaft having a longitudinal axis that defines a second axis of the chainsaw,
a driven gear coupled to the output shaft such that the driven gear rotates in response to rotation of the output shaft;
a sprocket coupled to the driven gear such that rotation of the driven gear rotates the sprocket;
a guide bar extending from the drive housing portion and having a longitudinal axis that defines a third axis of the chainsaw, the guide bar including an internal portion disposed within the drive housing portion and a projecting portion extending beyond a forward-most edge of the drive housing portion by a distance between 4 inches and 8 inches,
a chain supported on the guide bar and engaged with the sprocket such that rotation of the sprocket moves the chain along the guide bar, the chain including a plurality of cutting elements having a semi-chisel configuration;
a battery configured to provide power to the motor, the battery being received in the cavity along the first axis such that the battery substantially fills the cavity; and
a trigger switch positioned on the handle housing portion for controlling operation of the chainsaw,
wherein the first axis and the second axis define an included angle less than 75 degrees,
wherein the second axis and the third axis define a second included angle between 110 degrees and 130 degrees, and
wherein the first axis and the third axis define an external angle between 150 degrees and 170 degrees.

2. The chainsaw of claim 1, wherein the battery includes three battery cells with a lithium-ion chemistry.

3. The chainsaw of claim 2, wherein the motor is a brushed DC motor.

4. The chainsaw of claim 3, wherein the trigger switch includes an on/off switch.

5. The chainsaw of claim 1, wherein the chainsaw is configured to be operated with one hand.

6. The chainsaw of claim 5, wherein the first axis, the second axis, and the third axis are oblique with respect to each of the other axes.

7. The chainsaw of claim 1, wherein the driven gear is a bevel gear including teeth facing the lateral side of the drive housing portion.

8. The chainsaw of claim 1, wherein the motor is positioned above the guide bar.

9. The chainsaw of claim 1, further comprising a lubrication system configured to supply lubricant to the chain during operation of the chainsaw.

10. The chainsaw of claim 9, wherein the lubrication system includes a lubricant reservoir coupled to an exterior of the housing and a conduit extending from the lubricant reservoir into the drive housing portion.

11. A chainsaw comprising:
a housing including a handle housing portion, a motor housing portion, and a drive housing portion, the handle housing portion having a cavity extending along a longitudinal axis that defines a first axis of the chainsaw and at least one grip surface configured to be grasped during operation of the chainsaw;
a workpiece engaging member positioned on the drive housing portion and configured to engage a workpiece to provide a pivot point during a cutting operation of the chainsaw;
a brushed DC motor supported within the motor housing portion, the motor including an output shaft having a longitudinal axis that defines a second axis of the chainsaw,
a driven gear coupled to the output shaft such that the driven gear rotates in response to rotation of the output shaft;
a sprocket coupled to the driven gear such that rotation of the driven gear rotates the sprocket;
a guide bar extending from the drive housing portion and having a longitudinal axis that defines a third axis of the chainsaw, the guide bar including an internal portion disposed within the drive housing portion and a projecting portion extending beyond a forward-most edge of the drive housing portion by a distance between 4 inches and 8 inches,
a chain supported on the guide bar and engaged with the sprocket such that rotation of the sprocket moves the chain along the guide bar, the chain including a plurality of cutting elements having a semi-chisel configuration;
a battery configured to provide power to the motor, the battery being received in the cavity along the first axis such that the battery substantially fills the cavity; and
a trigger switch positioned on the handle housing portion for controlling operation of the chainsaw, the trigger switch including an on/off switch,
wherein the first axis and the second axis define an included angle less than 75 degrees, and
wherein the first axis, the second axis, and the third axis are oblique with respect to each of the other axes.

12. The chainsaw of claim 11, wherein the chainsaw is configured to be operated with one hand.

13. The chainsaw of claim 12, wherein the driven gear is a bevel gear.

14. The chainsaw of claim 13, wherein the motor is positioned above the guide bar.

15. The chainsaw of claim 14, further comprising a lubrication system configured to supply lubricant to the chain during operation of the chainsaw.

16. The chainsaw of claim 15, wherein the lubrication system includes a lubricant reservoir coupled to an exterior of the housing and a conduit extending from the lubricant reservoir into the drive housing portion.

17. A chainsaw comprising:
a housing including a handle housing portion, a motor housing portion, and a drive housing portion, the handle housing portion having a cavity extending along a longitudinal axis that defines a first axis of the chainsaw and at least one grip surface configured to be grasped during operation of the chainsaw;
a knob positioned on a lateral side of the drive housing portion, the knob including a round portion adjacent the drive housing portion and a graspable portion coupled to the round portion;
a motor supported by the motor housing portion, the motor including an output shaft having a longitudinal axis that defines a second axis of the chainsaw;
a driven gear coupled to the output shaft such that the driven gear rotates in response to rotation of the output shaft, wherein the driven gear is a bevel gear having teeth facing the lateral side of the drive housing portion;
a sprocket coupled to the driven gear such that rotation of the driven gear rotates the sprocket;
a guide bar extending from the drive housing portion and having a longitudinal axis that defines a third axis of the chainsaw;
a chain supported on the guide bar and engaged with the sprocket such that rotation of the sprocket moves the chain along the guide bar;
a battery pack configured to provide power to the motor, the battery pack being received in the cavity along the first axis such that the battery substantially fills the cavity; and
a trigger switch positioned on the handle housing portion for controlling operation of the chainsaw,
wherein the first axis and the second axis define an included angle less than 75 degrees,
wherein the second axis and the third axis define a second included angle between 110 degrees and 130 degrees, and
wherein the first axis and the third axis define an external angle between 150 degrees and 170 degrees.

18. The chainsaw of claim 17, wherein the first axis, the second axis, and the third axis are oblique with respect to each of the other axes.

19. The chainsaw of claim 17, wherein the chainsaw is configured to be operated with one hand.

20. The chainsaw of claim 17, wherein the motor is a brushed DC motor, and wherein the trigger switch includes an on/off switch.
